(19) United States
(12) Patent Application Publication
(10) Pub. No.: US 2017/0100772 A1
(43) Pub. Date: Apr. 13, 2017

(54) MANUFACTURING ARTICLE FROM METAL ALLOY

(71) Applicant: Caterpillar Inc., Peoria, IL (US)

(72) Inventors: Scott A. Johnston, East Peoria, IL (US); Cary J. Lyons, Morton, IL (US); Christopher A. Barnes, Peoria, IL (US)

(73) Assignee: Caterpillar Inc., Peoria, IL (US)

(21) Appl. No.: 14/877,246

(22) Filed: Oct. 7, 2015

(51) Int. Cl. B22D 46/00; B22D 23/00

(52) U.S. Cl. CPC B22D 46/00; B22D 23/00; B33Y 10/00

(57) ABSTRACT

A method for manufacturing an article from a metal alloy is described. The method includes supplying the metal alloy into a nozzle of a printing chamber, where temperature of the metal alloy is between a solidus and a liquidus temperature. Further, the method includes depositing the metal alloy in successive layers on a substrate plate, inside the printing machine, using the nozzle. The method also includes controlling movement of at least one of the nozzle and the substrate plate within the printing chamber based on an electronic data source of the article, where the electronic data source includes geometry of the article.

### TECHNICAL FIELD

The present disclosure relates to manufacturing of an article and, in particular, to a method and an apparatus for manufacturing the article from an metal alloy.

### BACKGROUND

With the development of technology, various kinds of manufacturing processes have emerged. Among the various kinds of manufacturing processes, additive manufacturing stands distinct from the conventional manufacturing techniques. Additive manufacturing involves a group of processes to manufacture a three-dimensional (3D) article by layer-wise deposition of molten or powdered material.

U.S. Pat. No. 5,746,844 describes a method and an apparatus for manufacturing a three-dimensional article. The described method includes providing a supply of substantially uniform size droplets of a desired material wherein each droplet has a positive or negative charge. The droplets are aligned into a narrow stream by passing the droplets through an alignment means. The alignment means repels each droplet toward an axis extending through the alignment means. Further, the droplets are deposited in a predetermined pattern at a predetermined rate onto a surface to form the three-dimensional article without the use of a mold.

### SUMMARY OF THE DISCLOSURE

According to an aspect of the present disclosure, a method for additive manufacturing of an article, from metal alloy, is described. In one embodiment, the method includes supplying the metal alloy into a nozzle of a printing chamber, where temperature of the metal alloy is between a solidus temperature and a liquidus temperature. Further, the method includes depositing the metal alloy in successive layers on a substrate plate, inside the printing chamber, using the nozzle. The method also includes controlling movement of at least one of the nozzle and the substrate plate within the printing chamber based on an electric data source of the article. The electronic data source includes the geometry of the article.

According to another aspect of the present disclosure, a printing apparatus implementing the above method is described. In other words, a printing apparatus for manufacturing an article from metal alloy is described. In one embodiment, the printing apparatus includes a printing chamber, a feed member configured to supply the metal alloy into the printing chamber. In this embodiment, the temperature of the metal alloy is between a solidus temperature and a liquidus temperature. Further, the printing apparatus includes a nozzle coupled to the feed member to receive the metal alloy. The nozzle is disposed in the printing chamber and configured to deposit the metal alloy in successive layers inside the printing chamber. The printing apparatus also includes a substrate plate disposed within the printing chamber for supporting the successive layers of the metal alloy.

According to another aspect of the present disclosure, article controller for controlling manufacturing of an article from metal alloy in a manufacturing system is described. The controller includes a first module operably coupled to a control valve of the manufacturing system to control supply of metal alloy into a nozzle of a printing apparatus. The temperature of the metal alloy is between a solidus and a liquidus temperature. The controller also includes a second module communicatively coupled to an electronic data source to control movement of the nozzle within a printing chamber of the manufacturing system based on inputs from the electronic data source, where the inputs include geometry of the article. The communicative coupling between the controller and the electronic data source also aids in depositing the metal alloy in successive layers, using the nozzle, inside the printing chamber, based on the geometry of the article. Further, the controller includes a third module communicatively coupled to an electrical heating means to regulate temperature of a substrate plate of the manufacturing system. The substrate plate is provided to support the successive layers of metal alloy thereon.

These and other aspects of the present disclosure would be described in greater detail in conjunction with the following figures. It should be noted that the description and figures merely illustrate the principles of the present disclosure and should not be construed as limited.

### BRIEF DESCRIPTION OF THE DRAWINGS

FIG. 1 illustrates a schematic of an exemplary manufacturing system, according to an embodiment of the present disclosure; and

FIG. 2 is a flowchart of a method for manufacturing an article, according to an embodiment of the present disclosure.

### DETAILED DESCRIPTION

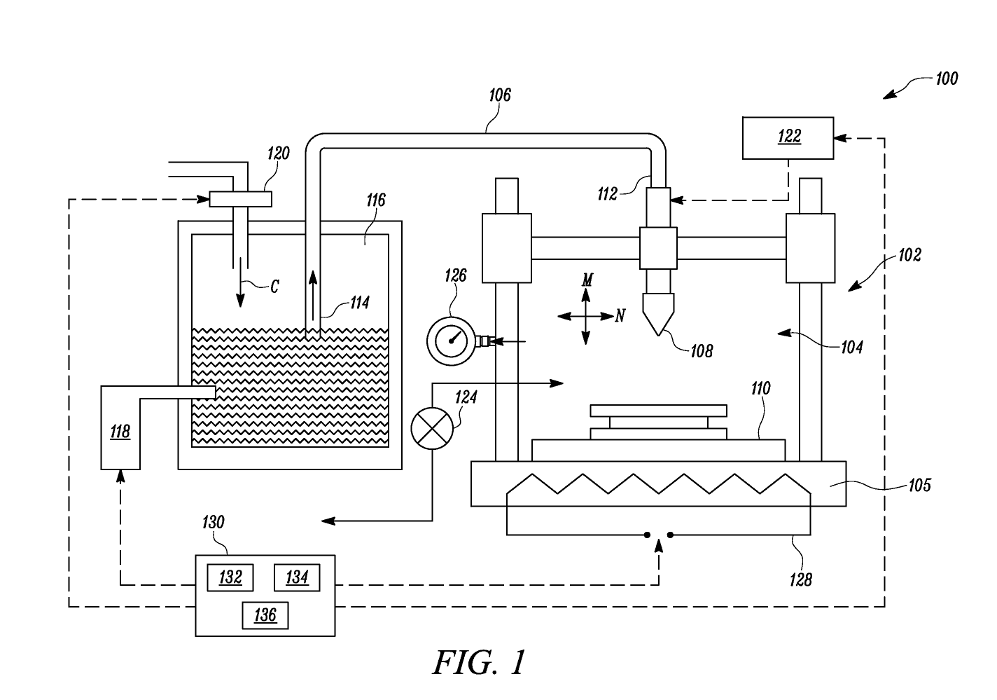

FIG. 1 illustrates a schematic of a manufacturing system 100 including a printing apparatus 102, according to an embodiment of the present disclosure. The printing apparatus 102 may be utilized for manufacturing an article from a metal alloy. According an embodiment of the present disclosure, the metal alloy is selected from one of aluminum alloy, copper alloy and magnesium alloy. The printing apparatus 102 may define a printing chamber 104. The printing chamber 104 may be, but not limiting to, a rectangular chamber, where at least one side of the printing chamber 104 is adapted to be displaced, to allow access inside the printing chamber 104. In an example, the at least one side of the printing chamber 104 may function as a door for the printing chamber 104, which can be pivotally moved from a closed position to an open position. Further, the printing chamber 104 may be mounted on a rigid platform, such as a base 105, such that the printing chamber 104 is not disturbed by any vibrations or shocks of small magnitude that may be incident on the base 105. It will be appreciated that the geometry, such as shape and size, of the printing chamber 104 may vary based on requirements.

In addition, the manufacturing system 100 may include a feed member 106 configured to supply the metal alloy into the printing chamber 104. In one example, the feed member 106 may be a pipe or conduit. The printing apparatus 102 may also include a nozzle 108. The nozzle 108 is in fluid communication with the feed member 106 and configured to deposit the metal alloy in form of successive layers inside the printing chamber 104. In particular, the metal alloy may be deposited on a substrate plate 110 within the printing chamber 104.

According to an aspect of the present disclosure, the feed member 106 may have a first end 112 and a second end 114. The first end 112 of the feed member 106 may be coupled to the nozzle 108 of the printing apparatus 102 and the second end 114 of the feed member 106 may be coupled to a reservoir 116. The reservoir 116 may be a tank or a source which is capable of storing the metal alloy in a semi-solid state. According to an embodiment of the present disclosure, the temperature of the metal alloy in the reservoir 116 is maintained between a solidus temperature and a liquidus temperature of the metal alloy. In one example, the metal alloy can be stored in a temperature range of about 450 degree Celsius (° C.) to about 600° C. For the purpose of maintaining the metal alloy in this temperature range, in one example, periphery of the reservoir 116 may be a covered by refractory bricks and/or asbestos lining, so that the heat within the reservoir 116 is not lost with the outer environment. In another example, pieces of metal alloy may be stored in the reservoir 116 and may be heated by a heating member 118. The heating member 118 may be, but not limiting to, a source of flame or an electrical heater. With the aid of the heating member 118, the pieces of metal alloy present in the reservoir 116 may be heated to a temperature between the solidus temperature and the liquidus temperature, to form the semi-solid metal.

The semi-solid metal alloy may be supplied to the printing chamber 104 through the feed member 106. The second end 114 of the feed member 106 may be coupled to the reservoir 116 and may be disposed at a certain height within the reservoir 116. In an embodiment, the compressed air C may be supplied into the reservoir 116 for forcing the semi-solid metal alloy through the feed member 106. Alternatively, a pump (not shown) may be provided to assist in supply of the semi-solid metal alloy to the nozzle 108 through the feed member 106. For convenience of the description, the semi-solid metal alloy will hereinafter be alternately referred to as the metal alloy.

Further, the nozzle 108 may be disposed in the printing chamber 104. In one example, the nozzle 108 may be attached to a top portion of the printing chamber 104. In another example, the nozzle 108 may be movably attached within the printing chamber 104. For instance, the nozzle 108 may be configured to move in at least one of a vertical direction M and a horizontal plane N. The nozzle 108 may be configured to deposit the metal alloy in successive layers inside the printing chamber 104. It will be understood that the nozzle 108 may be a pipe like structure and may have a varying cross-section along its longitudinal axis, where a first end of the nozzle 108 may have a diameter larger than a diameter of a second end of the nozzle 108. The first end of the nozzle 108 may be coupled to the first end 112 of the feed member 106 to receive the metal alloy from the reservoir 116 through the feed member 106. In addition, due to the tapered cross-section of the nozzle 108 at the second end, velocity with which the metal alloy exits the nozzle 108 may also be high enough to allow accurate deposition of successive layers of metal alloy on the substrate plate 110. The substrate plate 110 may be mounted on the base 105 of the printing chamber 104. In one example, the substrate plate 110 may be a rectangular plate made of copper or a copper alloy and having a substantially smooth surface finish.

In one aspect of the present disclosure, the deposition of the metal alloy, the movement of the nozzle 108 and the movement of the substrate plate 110 within the printing chamber 104 may be controlled based on an electronic data source 122. The electronic data source 122 source may include geometry of the article to be manufactured. The electronic data source 122, in one example, may be a computing device capable of receiving multiple inputs, from a user, regarding the geometry of the article. For instance, three-dimensional coordinates of one or more features of the article may be provided as inputs to the electronic data source 122. In an exemplary embodiment, the electronic data source 122 may be communicatively coupled to the nozzle 108 through, but not limiting to, one or more electrical wires.

Further, a vacuum pump 124 may be coupled to the printing chamber 104, as illustrated in the FIG. 1. According to an embodiment of the present disclosure, the vacuum pump 124 may be configured to remove air from the printing chamber 104 and create vacuum, such as a partial vacuum, inside the printing chamber 104. In addition, a pressure gauge 126 may also be provided attached to the printing chamber 104 to determine the pressure inside the printing chamber 104 during the operation of the vacuum pump 124. According to another embodiment of the present disclosure, a controlled atmosphere is created in the printing chamber 104. The controlled atmosphere includes regulating one or more of the several parameters, such as, temperature, oxygen level, carbon dioxide, moisture content etc. Furthermore, the printing apparatus 102 may be equipped with one or more devices to control the temperature of each of the successive layers of the metal alloy deposited on the substrate plate 110 during the manufacturing process. For the purpose, an electrical heating means 128 may be electrically coupled to the printing apparatus 102. In one example, the electrical heating means 128 may include one or more heating coils and each of the one or more heating coils may be embedded within the base 105 of the printing chamber 104 in a manner, such that the heat generated from the one or more heating coils may heat the substrate plate 110 mounted on the base 105. The one or more heating coils and the electrical heating means 128 may be selected based on the solidus temperature of the metal alloy used for manufacturing the article. During the manufacturing process, the heating coils and/or the electrical heating means 128 may be operated until the temperature reaches a predetermined threshold temperature. The predetermined threshold temperature can be understood as a temperature substantially equal to the solidus temperature, such that the semi-solid metal alloy deposited on the substrate plate 110 solidifies within a short time period. Accordingly, the electrical heating means 128 may facilitate in regulating the temperature of the substrate plate 110, thereby allowing solidification of the metal alloy within the printing chamber 104.

Furthermore, the manufacturing system 100 may include a controller 130 for controlling various factors during the operation of the printing apparatus 102. In one example, the controller 130 may be a processor that includes a single processing unit or a number of units, all of which include multiple computing units. The explicit use of the term ‘processor’ should not be construed to refer exclusively to hardware capable of executing a software application. Rather, in this example, the controller 130 may be implemented as one or more microprocessor, microcomputers, digital signal processor, central processing units, state machine, logic circuitries, and/or any device that is capable of manipulating signals based on operational instructions. Among the capabilities mentioned herein, the controller 130 may also be configured to receive, transmit, and execute computer-readable instructions.

In an embodiment of the present disclosure, the controller 130 can be configured to control one or more parameters during the manufacturing process. As such, the printing apparatus 102 may be configured to couple to the controller 130. Accordingly, the controller 130 can include modules, such as a first module 132, a second module 134, and a third module 136. The modules may be implemented as signal processor(s), logic circuitries, and/or any device or component that manipulate signals based on receipt of one or more instructions or inputs. For instance, the first module 132 of the controller 130 may be operably coupled to the control valve 120. The first module 132 may operate the control valve 120 to control the supply of metal alloy into the nozzle 108 of the printing apparatus 102. Further, the second module 134 of the controller 130 can be communicatively coupled to the electronic data source 122 to receive various inputs from the electronic data source 122. For example, a user may provide input few details into the electronic data source 122 regarding the geometry of the article to be manufactured in the printing chamber 104. On receipt of such inputs from the electronic data source 122, the controller 130 may be configured to convert the received inputs into computer-readable instructions, so that flow of semi-solid metal alloy through the nozzle 108 may be controlled. Further, the controller 130 may also control the movement of the nozzle 108 in at least one of the vertical direction M and the horizontal plane N, based on the geometry of the article to be manufactured. The printing apparatus 102 may be equipped with at least one of a chain-sprocket arrangement, rack-pinion arrangement, a hydraulic mechanism, a pneumatic mechanism, and an electronic mechanism to aid the movement of the nozzle 108. Furthermore, the controller 130 may control the movement of the substrate plate 110, such as a tilting movement of the substrate plate 110 with respect to the nozzle 108.

In addition, the third module 136 of the controller 130 may be communicatively coupled to the electrical heating means 128 to control the temperature of the substrate plate 110. Accordingly, the controller 130 may also be configured to regulate the temperature of the substrate plate 110 and, therefore, the temperature of each of the successive layers of the metal alloy deposited on the substrate plate 110. In addition, the controller 130 may be coupled to the heating member 118 for controlling the heating of the metal alloy stored in the reservoir 116. Although the description herein describes few capabilities of the controller 130, it will be appreciated that the functionalities of the controller 130 need not be construed to be limited to those described herein.

### INDUSTRIAL APPLICABILITY

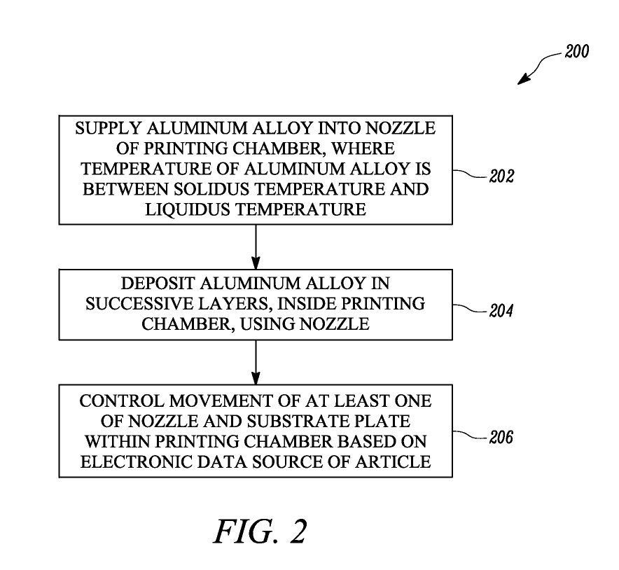

FIG. 2 illustrates a flowchart of a method 200 for manufacturing an article, according to an embodiment of the present disclosure. Further, the method 200 may be implemented in any suitable hardware, such that the hardware employed can perform the steps of the method 200 readily and on a real-time basis. For the convenience in description, various steps of the method 200 will be described in conjunction with FIG. 1 of the present disclosure.

Referring to the method 200, at step 202, metal alloy may be supplied into the nozzle 108 of the printing chamber 104, where temperature of the metal alloy is between a solidus temperature and a liquidus temperature. In other words, a semi-solid metal alloy may be supplied into the nozzle 108. In one example, metal alloy may be processed to its semi-solid form in the reservoir 116 with the aid of the heating member 118. The operation of the heating member 118 and an actuation of a control valve 120 for supplying the compressed air C into the reservoir 116 may be controlled by the controller 130, as illustrated in FIG. 1. The compressed air C may assist in forcing the semi-solid metal alloy into the feed member 106. The temperature range within which the metal alloy is supplied into the nozzle 108 may be in a range of about 450 degrees Celsius (° C.) to about 600° C.

Further, at step 204, the semi-solid metal alloy received by the nozzle 108 may be deposited in successive layers inside the printing chamber 104. The phrase ‘successive layers’ may be understood as a layer-wise deposition of the semi-solid metal alloy. For the purpose of obtaining such deposition in successive layers, in one example, the nozzle 108 may be subjected to movement in at least one of the vertical direction M and the horizontal plane N with respect to the printing chamber 104. In one example, the semi-solid metal alloy may be deposited on the substrate plate 110 disposed within the printing chamber 104, where the substrate plate 110 is to support the successive layers of the semi-solid metal alloy thereon.

Additionally, in one exemplary embodiment, the deposition of the semi-solid metal alloy may be based on an electronic data source 122 that includes the geometry of one or more features of article to be manufactured in the printing chamber 104. Furthermore, at step 206, the movement of the nozzle 108 and/or the substrate plate 110 may be controlled based on the electronic data source 122. In one example, the controller 130 may be configured to control the movements of the nozzle 108 within the printing chamber 104. For instance, a user may be allowed to input the geometry of the article into the electronic data source 122 by loading a supported file format. On receipt of such inputs by the user, and by virtue of communication between the controller 130 and the electronic data source 122, the controller 130 may convert the received inputs into computer readable instruction and/or corresponding electrical signals, to control the movement of the nozzle 108 and/or the substrate plate 100 within the printing chamber 104. With such arrangements and configurations, the printing apparatus 102 may efficiently implement the steps of the method 200 described herein. In addition, owing to the semi-solid state of the metal alloy is supplied and deposited in the printing chamber 104, the semi-solid metal alloy may solidify in a substantially short duration of time. Accordingly, the method 200 may also be cost effective and may involve reduced efforts.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method for manufacturing an article from metal alloy, the method comprising:
supplying the metal alloy into a nozzle of a printing chamber, wherein temperature of the metal alloy is between a solidus temperature and a liquidus temperature;
depositing the metal alloy in successive layers on a substrate plate, inside the printing chamber, using the nozzle; and
controlling movement of at least one of the nozzle and the substrate plate within the printing chamber based on inputs from an electronic data source of the article, wherein the inputs comprise geometry of the article.

2. The method of claim 1, wherein the metal alloy is selected from one of aluminum alloy, copper alloy and magnesium alloy.

3. The method of claim 1 further comprising creating vacuum in the printing chamber.

4. The method of claim 1 further comprising creating a controlled atmosphere in the printing chamber.

5. The method of claim 1 further comprising operating a control valve to control the supply of the metal alloy into the nozzle.

6. The method of claim 1, wherein the metal alloy is supplied within a temperature range of about 450 degree Celsius to about 600 degree Celsius.

7. The method of claim 1 further comprising controlling temperature of each of the successive layers of the metal alloy inside the printing chamber.

8. The method of claim 7, wherein the controlling temperature of each of the successive layers of the metal alloy comprises regulating temperature of the substrate plate by electrical heating.

9. The method of claim 1, wherein the movement of the nozzle comprises at least one of a horizontal movement and a vertical movement with respect to the printing chamber.

10. The method of claim 1, wherein the movement of the substrate plate comprises a tilting movement with respect to the nozzle.

11. A printing apparatus for manufacturing an article from metal alloy, the printing apparatus comprising:
a printing chamber;
a feed member configured to supply the metal alloy into the printing chamber, wherein temperature of the metal alloy is between a solidus temperature and a liquidus temperature;
a nozzle coupled to the feed member to receive the metal alloy, the nozzle is disposed in the printing chamber, wherein the nozzle is configured to deposit the metal alloy in successive layers inside the printing chamber; and
a substrate plate disposed within the printing chamber for supporting the successive layers of the metal alloy.

12. The printing apparatus of claim 11 further comprising a vacuum pump configured to create vacuum inside the printing chamber.

13. The printing apparatus of claim 11, wherein the feed member is coupled to a reservoir, the reservoir provided to store the metal alloy at the temperature between a solidus temperature and a liquidus temperature.

14. The printing apparatus of claim 11, wherein the printing apparatus is configured to be coupled to a controller, the controller is configured to control a movement of at least one of the nozzle and the substrate plate within the printing chamber.

15. The printing apparatus of claim 14, wherein the movement of at least one of the nozzle and the substrate plate is controlled by the controller based on inputs received from an electronic data source, wherein the inputs comprise geometry of the article.

16. The printing apparatus of claim 11, wherein the nozzle is configured to move in at least one of a horizontal and a vertical direction with respect to the printing chamber.

17. The printing apparatus of claim 11, wherein the substrate plate is configured to tilt with respect to the nozzle.

18. The printing apparatus of claim 11 further comprising an electrical heating means configured to control the temperature of each of the successive layers of the metal alloy inside the printing chamber.

19. The printing apparatus of claim 18, wherein the temperature of each of the successive layers of the metal alloy is controlled by regulating the temperature of the substrate plate.

20. A controller for controlling manufacturing of an article from metal alloy in a manufacturing system, the controller comprising:
a first module operably coupled to a control valve of the manufacturing system, the first module configured to control supply of the metal alloy into a nozzle of a printing apparatus, wherein temperature of the metal alloy is between a solidus temperature and a liquidus temperature;
a second module communicatively coupled to an electronic data source, the second module configured to:
deposit the metal alloy in successive layers on a substrate plate, inside the printing chamber, using the nozzle; and
control movement of at least one of the nozzle and the substrate plate within a printing chamber of the manufacturing system based on inputs from the electronic data source, wherein the inputs comprise geometry of the article; and
a third module communicatively coupled to an electrical heating means, the third module is configured to control temperature of a substrate plate of the manufacturing system, wherein the substrate plate is provided to support the successive layers of metal alloy thereon.
